(19) United States
(12) Patent Application Publication
(10) Pub. No.: US 2026/0134016 A1
(43) Pub. Date: May 14, 2026

(54) System and Method for the Identification of Duplicate Records, Relating to Identical or Equivalent Materials, in a Master File of Industrial Materials

(71) Applicant: Creactives Group SPA, Verona (IT)

(72) Inventor: Francesco Bellomi, Verona (IT)

(21) Appl. No.: 19/115,954

(22) PCT Filed: Sep. 21, 2023
(86) PCT No.: PCT/IB2023/059350

§ 371 Date: Mar. 27, 2025

(30) Foreign Application Priority Data
Sep. 28, 2022 (IT) 102022000019902

(51) Int. Cl. G06F 16/334; G06F 16/34

(52) U.S. Cl. CPC G06F 16/334; G06F 16/345

(57) ABSTRACT

A system for identification of duplicate records, relating to identical or equivalent materials, in a master file of industrial materials, which comprises a master file memory unit configured to store the master file of industrial materials comprising a plurality of records;

and further comprising:
a categorization module configured to associate the text description of the industrial material comprised in each master file record with a respective category selected from categories which are defined in a standard taxonomy and represent respective types of industrial material;
a search module configured to discover and extract at least one item of technical information about the industrial material from a text description comprised in each master file record; and
an analytical memory unit configured to store the standard taxonomy, and a plurality of technical information patterns grouped according to the plurality of categories of the standard taxonomy.

### CROSS-REFERENCE TO RELATED APPLICATION

This application is the National Stage of International Application No. PCT/IB 2023/059350 filed Sep. 21, 2023, which claims priority to and the benefit of Italian Application No. 102022000019902 filed Sep. 28, 2022, the disclosures of both of which are incorporated herein by this reference in their entireties.

### FIELD OF THE INVENTION

The present invention relates to a system and a method for the identification of records (also called entries) of a master file of industrial materials (also called objects) that relate to, i.e. that concern, materials that are identical in nature or are equivalent in function, in the context of an industrial process. Industrial materials are objects intended for use in an industrial process.

### BACKGROUND OF THE INVENTION

The system and the method according to the present invention are particularly, although non exclusively, useful and practical in the maintenance of master files of industrial materials in medium and/or large companies.

Note that in the present description the term “record” (or “entry”) indicates every single element comprised in a register or, more generally, in an ordered and homogeneous group of data items. Each record comprises a plurality of data items corresponding to a respective entity. Note also that in the present description, the term “master file” indicates a register that comprises a plurality of records (or entries). In the present invention, the register comprising the records is the master file of industrial materials and each record comprises a plurality of data items that relate to a respective material (or object).

Commonly, the organizational processes implemented and applied in medium and/or large companies entail the creation and maintenance of documents or registers which are structured to manage master files of the entities necessary to carrying out the company functions. For example, these entities can be customers, suppliers, raw materials, and industrial materials (or objects).

More specifically, in procurement (which comprises the activities of purchasing and provisioning goods and services directly and indirectly, monitoring and selecting suppliers, negotiating contracts, analyzing cost data, and optimizing purchase costs), a key role is played by material master files that catalog all the objects used in industrial processes, typically relating to the manufacture of industrial products or to the provision of services.

In general, an “industrial material” is a simple object, with unique technical information (for example make, model, attributes, technical parameters, technical specifications, distribution codes), which is purchased repeatedly on the market from one or more suppliers, kept in an organized manner in stockrooms, moved in a coordinated manner by logistical processes, and finally used in industrial processes, as mentioned typically relating to the manufacture of industrial products or to the provision of services.

Nowadays, the management and maintenance of master files of industrial materials in medium and/or large companies is entrusted to transactional software systems, specifically ERP (Enterprise Resource Planner) systems, supervised by human users. These known ERP systems, in addition to managing the master files, also manage the life cycle of requests for entities, in this case for industrial materials (or objects), which are described in the master files in the wider context of Enterprise Information Systems (EIS).

In general, the life cycle of requests for materials comprises the procurement, the logistics, the warehousing and the movement of these materials within the industrial processes.

In these conventional ERP systems, each record in the master file of industrial materials comprises an identification code of the respective material (known as the material code), a text description of the material, and other structured fields relating to that material.

The identification code of the master file record is unique within the ERP system, and therefore within the computer system, and is used to uniquely identify the respective material in transactions.

The text description of the master file record is used only by human users of the ERP system as a form of written documentation of the technical information of the respective material (as mentioned, for example make, model, attributes, technical parameters, technical specifications, distribution codes). As such, the text description is “opaque”, i.e. it cannot be interpreted directly by the ERP system managing the transactions of the computer system.

For example, the other structured fields of the master file record can comprise: goods categorization codes, pertinence to specific competence centers or cost centers, type or name of supplier, and/or other metadata.

Ensuring a high level of quality, or rather accuracy, of the data (known as data quality) of the master files of materials is an important object for medium and/or large companies, because the efficacy and efficiency of processes (for example procurement, logistics, warehousing, production) connected to these master files depends, at least partially, on this level of quality.

However, these conventional ERP systems are not devoid of drawbacks, including one of the most common types of errors found in master files in general, and in master files of industrial materials in particular, which consists of the presence of duplicate records. This duplication occurs when the same entity, in this case the same industrial material (or object), is recorded in two or more different records, with which two respective different identification codes are associated.

This type of error in master files managed by conventional ERP systems can lead to the loss of efficacy and efficiency in all the subsequent dependent processes. For example, a human user who questions the ERP or computer system to retrieve and read technical information about a specific entity, in this case a specific industrial material, might consult just one of the two or more records relating to the same entity and therefore might receive partial information about procurement, warehousing, stock on hand, consumption and the like.

The cause of the presence of these duplication errors in master files managed by ERP systems are many, and all are linked in one way or another to the process of entering and maintaining these master files in medium and/or large companies.

In theory, the main method of finding out whether an entity, in this case an industrial material, is already recorded, and therefore avoiding the addition of a duplicated record to the master file, consists of referring to the text descriptions of the existing records in the master file.

However, these texts can be inaccurate and/or incomplete, since typically the conventional ERP systems, and more generally computer systems, have limited space (for example 80 characters at most) for the description, which often is not sufficient to list all the technical information that is essential to identify the industrial material correctly.

In other words, the technical information about the entity, in this case the industrial material, contained in the master file record is potentially incomplete. Therefore, it is by no means certain that all the technical information necessary to uniquely identify the industrial material will be specified in the text description and/or in the other structured fields of the master file record.

Another cause of duplication errors in master files is that the text descriptions of the industrial materials are often written in different languages. This is a common occurrence in international companies, where text descriptions are used to dialog with local suppliers, and globally there are master files with descriptions in ten or more different languages. In this situation no human user in the company is capable of checking the records of the master files, using the known ERP systems, and distinguishing between all of the text descriptions.

Furthermore, a cause of duplication errors in master files is that, in medium and/or large companies, it is common that the responsibility for maintaining these master files is distributed among dozens or even hundreds of human users, with differing levels of ability and specific areas of experience. In this situation a human user, when entering a new record in the master file using conventional ERP systems, is not in a position to decide with a high level of confidence whether the entity in question, in this case the industrial material, is actually already recorded.

Independently of these sources of error, the number of records in master files in general, and in master files of industrial materials in particular, is very high (hundreds of thousands or millions, in big international companies), and therefore the individual human user is not capable of screening, in an economically justifiable length of time, an adequate number of records in the master file that are potential duplicates.

In some contexts, entering records in the master files is done automatically, for example when two computer systems are merged into one, typically as a consequence of the merger and/or acquisition of two companies that were previously separate. In these cases, usually-there may be a manual process of retrospective harmonization of the records, but such harmonization risks resulting in a very low level of quality, for the reasons described previously.

In other contexts, it can happen that separate computer systems have to coexist in the same company, and these systems, even if they individually have no duplicate records, globally assign different identification codes and/or use non-equivalent coding systems to refer to the same entities.

Currently software systems are known which cooperate with ERP systems and which implement methods for orchestrating and optimizing the process of manual evaluation of the quality of the data contained in master files and of manual harmonization of any duplicate records, carried out by human users.

However, these conventional systems do not avail of a precise limitation of the domain of analysis, or they offer a limitation of the domain of analysis based not on the text description, but on other structured fields of the master file records. However, the text description offers the best informational content, in terms of completeness and utility, about the industrial material (or object) and its technical information.

### BRIEF SUMMARY OF THE INVENTION

The aim of the present invention is to overcome the limitations of the known art described above, by devising a system and a method for the identification of duplicate records, relating to identical or equivalent materials, in a master file of industrial materials, that make it possible to obtain better effects than those be obtained with conventional solutions and/or similar effects at lower cost and with higher performance levels.

Within this aim, an object of the present invention is to devise a system and a method for the identification of duplicate records, relating to identical or equivalent materials, in a master file of industrial materials that make it possible to identify, automatically and heuristically, a subset of the master file records that potentially contains duplicates, this subset being sufficiently small and precise to make it an economically sustainable process to manually evaluate the quality of the data in the master files and to manually harmonize any duplicate records, said process being carried out by expert human users.

Another object of the present invention is to devise a system and a method for the identification of duplicate records, relating to identical or equivalent materials, in a master file of industrial materials, that make it possible to support the processes of manual evaluation of the quality of the data contained in master files and of manual harmonization of any duplicate records, carried out by expert human users, using the linguistic analysis of the text of the text description of the master file records.

A further object of the present invention is to devise a system and a method for the identification of duplicate records, relating to identical or equivalent materials, in a master file of industrial materials, that make it possible to support the processes of manual evaluation of the quality of the data contained in master files and of manual harmonization of any duplicate records, carried out by expert human users, independently of the language in which these data items are written, in particular the text description of the master file records.

Another object of the present invention is to devise a system and a method for the identification of duplicate records, relating to identical or equivalent materials, in a master file of industrial materials, that make it possible to easily maintain master files of materials that comprise a very large number of records (hundreds of thousands or millions, in big international companies).

Not least an object of the present invention is to provide a system and a method for the identification of duplicate records, relating to identical or equivalent materials, in a master file of industrial materials that are highly reliable, easily and practically implemented, and economically competitive when compared to the known art.

This aim and these and other objects which will become more apparent hereinafter are achieved by a system for the identification of duplicate records, relating to identical or equivalent materials, in a master file of industrial materials, which comprises a master file memory unit configured to store said master file of industrial materials comprising a plurality of records, each master file record comprising a text description of a respective industrial material,

characterized in that it comprises:
a categorization module configured to associate said text description of said industrial material comprised in each master file record, and therefore said master file record, with a respective category selected from a plurality of categories which are defined in a standard taxonomy and represent respective types of industrial material;
a search module configured to discover and extract at least one item of technical information about said industrial material from said text description comprised in each master file record, via the recognition of a respective pattern from a group of technical information patterns associated with said category selected by said categorization module; and
an analytical memory unit configured to store said standard taxonomy comprising said plurality of categories that represent respective types of industrial material, and a plurality of technical information patterns grouped according to said plurality of categories of said standard taxonomy.

The above aim and objects are also achieved by a method for the identification of duplicate records, relating to identical or equivalent materials, in a master file of industrial materials, by means of:
a master file memory unit configured to store said master file of industrial materials comprising a plurality of records, each master file record comprising a text description of a respective industrial material; and
an analytical memory unit configured to store a standard taxonomy comprising a plurality of categories that represent respective types of industrial material, and a plurality of technical information patterns grouped according to said plurality of categories of said standard taxonomy;
   characterized in that it comprises the steps of:
associating said text description of said industrial material comprised in each master file record, and therefore said master file record, with a respective category selected from said plurality of categories which are defined in said standard taxonomy and represent respective types of industrial material, by means of a categorization module; and
discovering and extracting at least one item of technical information about said industrial material from said text description comprised in each master file record, via the recognition of a respective pattern from a group of technical information patterns associated with said category selected by said categorization module, by means of a search module.

### BRIEF DESCRIPTION OF THE DRAWINGS

Further characteristics and advantages of the present invention will become more apparent from the description of a preferred, but not exclusive, embodiment of the system and of the method for the identification of duplicate records, relating to identical or equivalent materials, in a master file of industrial materials according to the invention, illustrated by way of non-limiting example with the aid of the accompanying drawings wherein:

FIG. 1 is a block diagram that schematically illustrates an embodiment of the system for the identification of duplicate records, relating to identical or equivalent materials, in a master file of industrial materials according to the present invention;

FIG. 2 is a flowchart that schematically illustrates an embodiment of the method for the identification of duplicate records, relating to identical or equivalent materials, in a master file of industrial materials according to the present invention.

### DETAILED DESCRIPTION OF THE INVENTION

Preliminarily, it should be noted that the peculiarity of the system and of the method for the identification of duplicate records, relating to identical or equivalent materials, in a master file of industrial materials according to the present invention consists in the analysis of the text description of the records of the master file of industrial materials using a combination of automatic techniques of natural language processing and natural language understanding, adapted to the domain of this specific type of data, i.e. data relating to industrial materials, with automatic techniques of text mining for extracting structured information from natural language text, also adapted to the domain of this specific type of data, i.e. data relating to industrial materials.

In brief, the modules described below, i.e. pre-analysis module 14, categorization module 15, search module 16 and selection module 17, use natural language processing techniques and text mining techniques. Natural language processing techniques and text mining techniques are studied in the branch of computer science commonly known as computational linguistics.

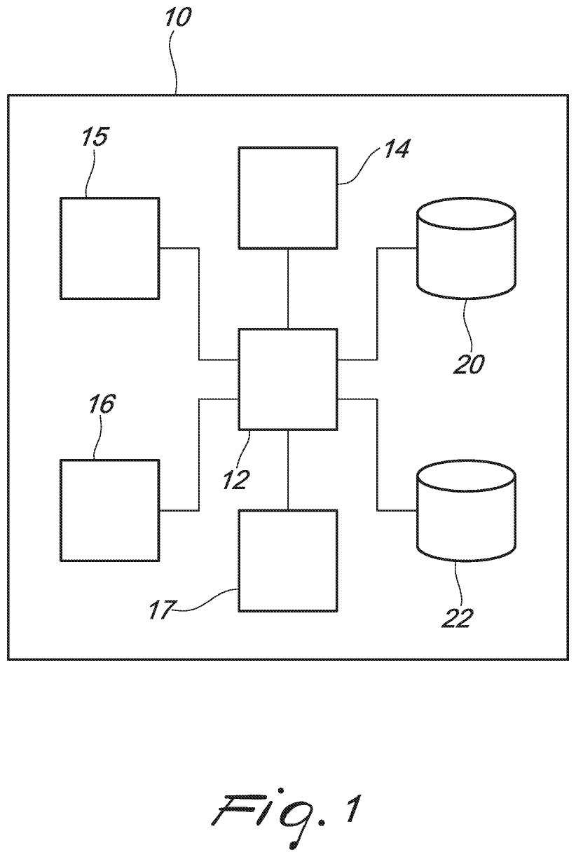

With reference to FIG. 1, the system for the identification of duplicate records, relating to identical or equivalent materials, in a master file of industrial materials according to the present invention, generally designated by the reference numeral 10, substantially comprises: an electronic control unit 12, a categorization module 15, a search module 16, a master file memory unit 20 and an analytical memory unit 22. Preferably, the system 10 for the identification of duplicate records according to the invention further comprises a pre-analysis module 14. Preferably, the system 10 for the identification of duplicate records according to the invention further comprises a selection module 17.

The electronic control unit 12 is the main functional element of the system 10 for the identification of duplicate records, relating to identical or equivalent materials, in a master file of industrial materials according to the invention, and for this reason it is functionally connected and in communication with the other elements comprised in the system 10 for the identification of duplicate records.

The electronic control unit 12 of the system 10 for the identification of duplicate records is provided with suitable capacity for processing and for interfacing with the other elements of the system 10 for the identification of duplicate records, and it is configured to command, control and coordinate the operation of the elements of the system 10 for the identification of duplicate records with which it is functionally connected and in communication.

The master file memory unit 20 of the system 10 for the identification of duplicate records, relating to identical or equivalent materials, according to the invention is configured to store, i.e. record, a master file of industrial materials comprising a plurality of records, where each master file record comprises a plurality of data items relating to a respective industrial material (or object). Each record in the master file of industrial materials, stored in the master file memory unit 20, comprises a text description of the respective industrial material (or object). Advantageously, each record in the master file of industrial materials, stored in the master file memory unit 20, comprises an identification code of the respective industrial material (or object).

As mentioned, using the text description of the master file record as a source of technical information about the industrial material (or object) is fundamental, because this text description is the only element of the master file record that contains precise information about the nature of the recorded industrial material (or object).

The pre-analysis module 14 of the system 10 for the identification of duplicate records, relating to identical or equivalent materials, in a master file of industrial materials according to the invention is configured to discover and extract at least one feature of the industrial material (an activity known as feature engineering) from the text description contained in each record in the master file of industrial materials, stored in the master file memory unit 20. It should be noted that in the present description the term “feature” indicates briefly a characteristic, a property and/or an attribute of the industrial material (or object).

Advantageously, the pre-analysis module 14 is configured to operate optimally on the text descriptions of industrial materials (or objects), which as mentioned are comprised in the records of the master file of industrial materials, and are characterized by short texts, in multiple languages, using technical jargon, and containing a great deal of numeric technical information.

Preferably, in light of the domain of analysis that comprises short descriptions of industrial materials (or objects), the pre-analysis module 14 is further configured to extract only features represented by words in the text description that are nouns and/or adjectives, and to ignore (i.e. not extract) features represented by words in the text description that are verbs and/or adverbs.

Preferably, in light of the domain of analysis that comprises short descriptions of industrial materials (or objects), the pre-analysis module 14 is further configured to ignore (i.e. not extract) features represented by words in the text description that are repetitions of previous words.

Advantageously, the pre-analysis module 14 is further configured to associate a weight with each feature of the industrial material (or object), so that some (“weightier”) features are evaluated as being more important than other (“less weighty”) features.

In an embodiment, the pre-analysis module 14 can assign greater weight, and therefore greater importance, to “short” numbers (made up of fewer digits), which often identify technical specifications, over “long” numbers (made up of many digits), which often identify codes specific to the maker.

In an embodiment, the pre-analysis module 14 can assign greater weight, and therefore greater importance, to the first words of the text description of the industrial material (or object) over the last words of that text description. This distribution of weight, and therefore of importance, based on a statistical analysis, is peculiar to the present invention because it is not true for common sentences.

Advantageously, the pre-analysis module 14 is configured to optimally operate on text descriptions of the industrial materials (or objects) in different languages.

In an embodiment, the pre-analysis module 14 can assign less weight, and therefore less importance, to the features of the industrial material (or object) associated with linguistic forms that are ambiguous between various languages, these features being pinpointed on the basis of an extensive analysis of the vocabularies of the various languages, so as to reduce the ambiguity between different languages.

The features of the industrial material (or object), discovered and extracted by the pre-analysis module 14, are fed as input to the categorization module 15, preferably in structured form.

The categorization module 15 of the system 10 for the identification of duplicate records, relating to identical or equivalent materials, in a master file of industrial materials according to the invention is configured to associate the text description of the industrial material (or object) contained in each record in the master file of industrial materials, and therefore the master file record itself, with a respective category selected from a plurality of categories defined in a standard taxonomy. Each category of the standard taxonomy represents a respective type of industrial material (or object).

The analytical memory unit 22 of the system 10 for the identification of duplicate records, relating to identical or equivalent materials, in a master file of industrial materials according to the invention is configured to store, i.e. record, the standard taxonomy, which is extremely granular and extensive (for example an axle with more than 140,000 categories), comprising the plurality of categories that represent the types of industrial material (or object).

Advantageously, the categorization module 15 is configured to operate using the combination of a multilayer neural network and a naive Bayes classifier.

Preferably, the categorization module 15 is configured to associate the text description of the industrial material (or object), represented briefly by the features previously discovered and extracted from the pre-analysis module 14, with a corresponding category selected from the plurality of categories defined in the standard taxonomy.

The category of the industrial material (or object), selected by the categorization module 15, is fed as input to the search module 16, preferably in structured form.

The search module 16 of the system 10 for the identification of duplicate records, relating to identical or equivalent materials, in a master file of industrial materials according to the invention is configured to discover and extract at least one item of technical information about the industrial material (as mentioned, for example make, model, attributes, technical parameters, technical specifications, distribution codes) from the text description contained in each record of the master file of industrial materials, via the recognition of a respective pattern (i.e. via pattern-matching) from a group of technical information patterns associated with the category previously selected by the categorization module 15. These patterns are predefined, and each one of them is associated with at least one category of the standard taxonomy.

The analytical memory unit 22 of the system 10 for the identification of duplicate records is further configured to store, i.e. record, a plurality of technical information patterns, which as mentioned are predefined. These technical information patterns are grouped under the categories of the standard taxonomy. In practice, the plurality of technical information patterns comprises various groups of technical information patterns, where each group is associated with a corresponding category of the standard taxonomy. It should be noted that a same technical information pattern can belong to more than one group, and therefore can be associated with more than one category of the standard taxonomy.

Advantageously, the search module 16 is configured to solve possible ambiguities in the interpretation of the text description of the industrial material (or object) contained in each record in the master file of industrial materials, and therefore in the recognition of the technical information pattern, this resolution being based on the statistical analysis of a corpus of historical data of a specific type.

Advantageously, the analytical memory unit 22 of the system 10 for the identification of duplicate records is further configured to store, i.e. record, a plurality of corpora of historical data, each one relating to a specific type.

The category of the industrial material (or object), selected by the categorization module 15, and the technical information about the industrial material (or object), discovered and extracted by the search module 16, are fed as input to the selection module 17, preferably in structured form.

The selection module 17 of the system 10 for the identification of duplicate records, relating to identical or equivalent materials, in a master file of industrial materials according to the invention is configured to select and extract a plurality of records from the master file of industrial materials, where these master file records are associated with a common category of industrial material (or object), and where the technical information about the industrial material (or object), to which these master file records relate, is identical or equivalent.

In an embodiment, the plurality of records in the master file of industrial materials, selected and extracted by the selection module 17, can be presented to a human user by way of adapted means for display (not shown), such as for example a screen.

Advantageously, the selection module 17 is configured to calculate an assessment metric of similarity between each pair of records in the master file of industrial materials, based on the respective categories and especially on the respective technical information of the industrial materials (or objects), and to select and extract the plurality of records from the master file of industrial materials, where the value of the assessment metric of similarity of these master file records is positioned in a predefined range.

This assessment metric of similarity makes it possible to associate each pair of records in the master file of industrial materials with a degree of confidence of the possibility that these two records refer to an identical or equivalent industrial material (or object).

In an embodiment, the plurality of records in the master file of industrial materials, selected and extracted by the selection module 17, can be presented to a human user in order and/or grouped under the value of the assessment metric of similarity.

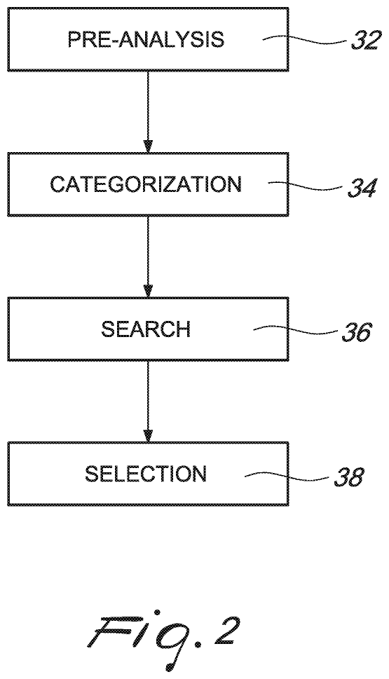

With reference to FIG. 2, the method for the identification of duplicate records, relating to identical or equivalent materials, in a master file of materials, in particular industrial materials, according to the present invention comprises the steps described below.

Preferably, in step 32, the pre-analysis module 14 of the system 10 for the identification of duplicate records, relating to identical or equivalent materials, in a master file of industrial materials according to the invention discovers and extracts at least one feature of the industrial material (an activity known as feature engineering) from the text description contained in each record in the master file of industrial materials.

The features of the industrial material (or object), discovered and extracted in step 32 by the pre-analysis module 14, are fed as input to the categorization module 15, preferably in structured form.

In step 34, the categorization module 15 of the system 10 for the identification of duplicate records, relating to identical or equivalent materials, in a master file of industrial materials according to the invention associates the text description of the industrial material (or object) contained in each record in the master file of industrial materials, and therefore the master file record itself, with a respective category selected from a plurality of categories defined in a standard taxonomy. Each category of the standard taxonomy represents a respective type of industrial material (or object).

Preferably, still in step 34, the categorization module 15 associates the text description of the industrial material (or object), briefly represented by the features previously discovered and extracted from the pre-analysis module 14, with a corresponding category selected from the plurality of categories defined in the standard taxonomy.

The category of the industrial material (or object), selected in step 34 by the categorization module 15, is fed as input to the search module 16, preferably in structured form.

In step 36, the search module 16 of the system 10 for the identification of duplicate records, relating to identical or equivalent materials, in a master file of industrial materials according to the invention discovers and extracts at least one item of technical information about the industrial material (as mentioned, for example make, model, attributes, technical parameters, technical specifications, distribution codes) from the text description contained in each record of the master file of industrial materials, via the recognition of a respective pattern (i.e. via pattern-matching) from a group of technical information patterns associated with the category previously selected by the categorization module 15. These patterns are predefined, and each one of them is associated with at least one category of the standard taxonomy.

Advantageously, still in step 36, the search module 16 solves possible ambiguities in the interpretation of the text description of the industrial material (or object) contained in each record in the master file of industrial materials, and therefore in the recognition of the technical information pattern, this resolution being based on the statistical analysis of a corpus of historical data of a specific type.

The category of the industrial material (or object), selected in step 34 by the categorization module 15, and the technical information about the industrial material (or object), discovered and extracted in step 36 by the search module 16, are fed as input to the selection module 17, preferably in structured form.

Preferably, in step 38, the selection module 17 of the system 10 for the identification of duplicate records, relating to identical or equivalent materials, in a master file of industrial materials according to the invention selects and extracts a plurality of records from the master file of industrial materials, where these master file records are associated with a common category of industrial material (or object), and where the technical information about the industrial material (or object), to which these master file records relate, is identical or equivalent.

Advantageously, still in step 38, the selection module 17 calculates an assessment metric of similarity between each pair of records in the master file of industrial materials, based on the respective categories and especially on the respective technical information of the industrial materials (or objects), and selects and extracts the plurality of records from the master file of industrial materials, where the value of the assessment metric of similarity of these master file records is positioned in a predefined range.

This assessment metric of similarity makes it possible to associate each pair of records in the master file of industrial materials with a degree of confidence of the possibility that these two records refer to an identical or equivalent industrial material (or object).

In practice it has been found that the system and the method for the identification of duplicate records according to the present invention fully achieves the set aim and objects. In particular, it has been seen that the system and the method for the identification of duplicate records, relating to identical or equivalent materials, in a master file of industrial materials, thus conceived, make it possible to overcome the qualitative limitations of the known art, in that they make it possible to obtain better effects than those obtained with conventional solutions and/or similar effects at lower cost and with higher performance levels.

An advantage of the system and of the method for the identification of duplicate records, relating to identical or equivalent materials, in a master file of industrial materials according to the present invention consists in that they make it possible to identify, automatically and heuristically, a subset of the master file records that potentially contains duplicates, this subset being sufficiently small and precise to make it an economically sustainable process to manually evaluate the quality of the data in the master files and to manually harmonize any duplicate records, said process being carried out by expert human users.

Another advantage of the system and of the method for the identification of duplicate records, relating to identical or equivalent materials, in a master file of industrial materials according to the present invention consists in that they make it possible to support the processes of manual evaluation of the quality of the data contained in master files and of manual harmonization of any duplicate records, carried out by expert human users, using the linguistic analysis of the text of the text description of the master file records.

A further advantage of the system and of the method for the identification of duplicate records, relating to identical or equivalent materials, in a master file of industrial materials according to the present invention consists in that they make it possible to support the processes of manual evaluation of the quality of the data contained in master files and of manual harmonization of any duplicate records, carried out by expert human users, independently of the language in which these data items are written, in particular the text description of the master file records.

Another advantage of the system and of the method for the identification of duplicate records, relating to identical or equivalent materials, in a master file of industrial materials according to the present invention consists in that they make it possible to easily maintain master files of materials that comprise a very large number of records (hundreds of thousands or millions, in big international companies).

Although the system and the method for the identification of duplicate records, relating to identical or equivalent materials, in a master file of materials according to the invention have been devised in particular for the maintenance of master files of industrial materials in medium and/or large companies, they can also be used, more generally, for the maintenance of master files of materials of any type in companies of any size.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

1-12. (canceled)

13. A system for identification of duplicate records, relating to identical or equivalent materials, in a master file of industrial materials, which comprises a master file memory unit configured to store said master file of industrial materials comprising a plurality of records, each master file record comprising a text description of a respective industrial material, and further comprising:
a categorization module configured to associate said text description of said industrial material comprised in each master file record, and therefore said master file record, with a respective category selected from a plurality of categories which are defined in a standard taxonomy and represent respective types of industrial material;
a search module configured to discover and extract at least one item of technical information about said industrial material from said text description comprised in each master file record, via recognition of a respective pattern from a group of technical information patterns associated with said category selected by said categorization module; and
an analytical memory unit configured to store said standard taxonomy comprising said plurality of categories that represent respective types of industrial material, and a plurality of technical information patterns grouped according to said plurality of categories of said standard taxonomy.

14. The system for identification of duplicate records according to claim 13, further comprising a pre-analysis module configured to discover and extract at least one feature of said industrial material from said text description comprised in each record in said master file of industrial materials.

15. The system for identification of duplicate records according to claim 13, wherein said categorization module is configured to associate said text description of said industrial material, represented in summary by said at least one feature discovered and extracted by said pre-analysis module, with said respective category selected from said plurality of categories of said standard taxonomy.

16. The system for identification of duplicate records according to claim 13, further comprising a selection module configured to select and extract a plurality of records from said master file of industrial materials, wherein said master file records are associated with a common category of industrial material and wherein said at least one item of technical information about said industrial material, referenced in said master file records, is identical or equivalent.

17. The system for identification of duplicate records according to claim 16, wherein said selection module is configured to calculate an assessment metric of similarity between each pair of records in said master file of industrial materials, and to select and extract said plurality of records from said master file of industrial materials, wherein the value of said assessment metric of similarity of said master file records is positioned in a predefined range.

18. The system for identification of duplicate records according to claim 13, wherein said search module is configured to solve any ambiguities in interpretation of said text description of said industrial material comprised in each master file record, and thus in the recognition of said technical information pattern, said resolution being based on statistical analysis of a corpus of historical data of a specific type, said analytical memory unit being further configured to store a plurality of corpora of historical data, each one relating to a specific type.

19. A method for identification of duplicate records, relating to identical or equivalent materials, in a master file of industrial materials, by means of:
a master file memory unit configured to store said master file of industrial materials comprising a plurality of records, each master file record comprising a text description of a respective industrial material; and
an analytical memory unit configured to store a standard taxonomy comprising a plurality of categories that represent respective types of industrial material, and a plurality of technical information patterns grouped according to said plurality of categories of said standard taxonomy; wherein it comprises the steps of:
associating said text description of said industrial material comprised in each master file record, and therefore said master file record, with a respective category selected from said plurality of categories which are defined in said standard taxonomy and represent respective types of industrial material, by means of a categorization module; and
discovering and extracting at least one item of technical information about said industrial material from said text description comprised in each master file record, via the recognition of a respective pattern from a group of technical information patterns associated with said category selected by said categorization module, by means of a search module.

20. The method for identification of duplicate records according to claim 19, further comprising a step of discovering and extracting at least one feature of said industrial material from said text description comprised in each record in said master file of industrial materials, by means of a pre-analysis module.

21. The method for identification of duplicate records according to claim 20, wherein in said step of associating said text description of said industrial material with said respective category selected from said plurality of categories of said standard taxonomy, said text description of said industrial material is represented in summary by said at least one feature discovered and extracted by said pre-analysis module.

22. The method for identification of duplicate records according to claim 19, further comprising a step of selecting and extracting a plurality of records from said master file of industrial materials, wherein said master file records are associated with a common category of industrial material and wherein said at least one item of technical information about said industrial material, referenced in said master file records, is identical or equivalent, by means of a selection module.

23. The method for identification of duplicate records according to claim 22, wherein said step of selecting and extracting said plurality of records in said master file of industrial materials further comprises the step of calculating an assessment metric of similarity between each pair of records in said master file of industrial materials, and selecting and extracting said plurality of records from said master file of industrial materials, wherein the value of said assessment metric of similarity of said master file records is positioned in a predefined range, by means of said selection module.

24. The method for identification of duplicate records according to claim 20, wherein said step of discovering and extracting at least one item of technical information about said industrial material from said text description further comprises the step of solving any ambiguities in the interpretation of said text description of said industrial material comprised in each master file record, and thus in the recognition of said technical information pattern, by means of said search module, said resolution being based on the statistical analysis of a corpus of historical data of a specific type, said analytical memory unit being further configured to store a plurality of corpora of historical data, each one relating to a specific type.
